(19) United States
(12) Patent Application Publication
(10) Pub. No.: US 2008/0289453 A1
(43) Pub. Date: Nov. 27, 2008

(54) Wrench apparatus with adjustable head

(75) Inventors: Glenn Robinson, Coral Springs, FL (US); Dan M. De La Rosa, Coral Springs, FL (US)

Correspondence Address: Dan M. DeLaRosa, Esq., Suite 24C, 300 E. 77th Street, New York, NY, 10075, US

(73) Assignee: IBT Holdings, LLC

(21) Appl. No.: 12/152,973

(22) Filed: May 19, 2008

Related U.S. Application Data
(60) Provisional application No. 60/931,549, filed on May 25, 2007.

(51) Int. Cl. B25B 13/28; B25B 23/00

(52) U.S. Cl. 81/90.2; 81/177.1

(57) ABSTRACT

A wrench device having an adjustable head is provided, and the device comprises: a handle having opposing top and bottom ends, the top end having a protrusion, and the protrusion having a plurality of external slots; a wrench head having opposing top and bottom ends, the top end having at least one stationary wrench contact surface and at least one moveable wrench contact surface, and the bottom end of the wrench head comprising a U-shaped component designed to interact with the protrusion of the top end of the handle; a device for controlling the movement of the moveable wrench contact surface to determine a distance between the stationary wrench contact surface and the moveable wrench contact surface; and a device for engaging the slots of the protrusion to thereby allow movement of the wrench head and lock the head to a desired position.

### RELATED APPLICATION

This application is related to U.S. Provisional Application Ser. No. 60/931,549, entitled “Wrench Apparatus With Adjustable Head” which was filed on May 25, 2007.

### BACKGROUND OF THE INVENTION

1. Field of the Invention

This invention relates to a wrench apparatus and more particularly, a wrench apparatus with adjustable head and adjustable head angles.

2. Description of the Related Art

There are various patents that cover ratchets and ratchet wrenches with adjustable angles. These ratchet devices have a handle and a head wherein the head is pivotably attached to the head to allow for movement of the head in different angles. U.S. Pat. No. 3,779,107 to Avery relates to a ratchet wrench with a fork-shaped handle and a moveable head. U.S. Pat. No. 4,901,608 to Shieh provides for a ratchet wrench with an adjustable head angle. Shieh uses a Y-shaped handle attached to a head with two gears engaging one another to allow for the adjustable head angle. U.S. Pat. No. 6,895,839 to Hsien relates to a control mechanism for adjusting the head of a ratchet wrench and the control mechanism uses a polygonal shaped hole and corresponding portion on a pin.

Unlike the prior art, the present invention provides for wrenches and wrench devices with adjustable heads and adjustable wrench contact surfaces as well as different control mechanism for movement and locking of the wrench head.

### SUMMARY OF THE INVENTION

In one embodiment, the present invention relates to a wrench device having an adjustable head, and the device comprises: a handle having opposing top and bottom ends, the top end having a protrusion, and the protrusion having a plurality of external slots; a wrench head having opposing top and bottom ends, the top end having at least one stationary wrench contact surface and at least one moveable wrench contact surface, and the bottom end of the wrench head comprising a U-shaped component designed to interact with the protrusion of the top end of the handle; a device for controlling the movement of the moveable wrench contact surface to determine a distance between the stationary wrench contact surface and the moveable wrench contact surface; and a device for engaging the slots of the protrusion to thereby allow movement of the wrench head and lock the head to a desired position.

In another embodiment, the wrench device further comprises a device for activating the release and the locking of the head in a desired position. In still another embodiment, the protrusion comprises an aperture and the device further comprises a pin for securing the wrench head to the handle by insertion of the pin into the aperture of the protrusion. In yet another embodiment, the release and locking device comprises a pin and a spring. In still yet another embodiment, the wrench head is designed to rotate about an axis from about 0 degrees to about 180 degrees.

In a further embodiment, the bottom end of the handle comprises a grip. In another further embodiment, the release and locking device comprises push mechanism. In yet a further embodiment, the release and locking device comprises sliding mechanism. In still a further embodiment, the external slots of the protrusion functions as a gear.

In still yet a further embodiment, the present invention provides for a wrench device having an adjustable head, and the device comprises: a handle having opposing top and bottom ends, the top end having a protrusion, the protrusion having a plurality of apertures; a wrench head having opposing top and bottom ends, the top end having at least one stationary wrench contact surface and at least one moveable wrench contact surface, the bottom end of said wrench head comprising a U-shaped component designed to interact with the protrusion of the top end of the handle; a device for controlling the movement of the moveable wrench contact surface to determine a distance between the stationary wrench contact surface and the moveable wrench contact surface; and a device for engaging the apertures of the protrusion to thereby allow movement of the wrench head and lock the head to a desired position.

In a further embodiment, the protrusion comprises a central aperture and the device further comprises a pin for securing the wrench head to the handle by insertion of the pin into the aperture of the protrusion. In another further embodiment, the wrench device further comprises a device for activating the release and the locking of the wrench head in a desired position.

In yet another further embodiment, the release and locking device comprises a pin and a spring. In still another further embodiment, the wrench head is designed to rotate about an axis from about 0 degrees to about 180 degrees. In still yet another further embodiment, the bottom end of the handle comprises a grip. In another embodiment, the release and locking device comprises push mechanism.

In yet another embodiment, the present invention provides for a wrench device having an adjustable head, and the device comprises: a handle having opposing top and bottom ends, and the top end having a U-shaped component; a wrench head having opposing top and bottom ends, the top end having at least one stationary wrench contact surface and at least one moveable wrench contact surface, the bottom end of the wrench head comprising a protrusion designed to interact with the U-shaped component of the top end of the handle, and the protrusion having a plurality of grooves; a device for controlling the movement of the moveable wrench contact surface to determine a distance between the stationary wrench contact surface and the moveable wrench contact surface; and a device for engaging the grooves of the protrusion to thereby allow movement of the wrench head and lock the head to a desired position, and the device comprises a sliding mechanism which engages the grooves.

In still another embodiment, the protrusion comprises a central aperture and the device further comprises a pin for securing the wrench head to the handle by insertion of the pin into the aperture of the protrusion. In a further embodiment, the wrench head is designed to rotate about an axis from about 0 degrees to about 180 degrees. In another further embodiment, the bottom end of said handle comprises a grip.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a front perspective view of one of the embodiments of the present invention;

FIG. 2 is a side perspective view of FIG. 1 showing the movement of the wrench head;

FIG. 3 is an exploded view of the components of another embodiment of the present invention using the apertures in the protrusion of top side of the handle with a push button mechanism; and

FIG. 4 is a frontal perspective view of another embodiment of the present invention with a sliding mechanism.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION:

As required, detailed embodiments of the present invention are disclosed herein; however, it is to be understood that the disclosed embodiments are merely exemplary of the invention that may be embodied in various forms. The figures are not necessary to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

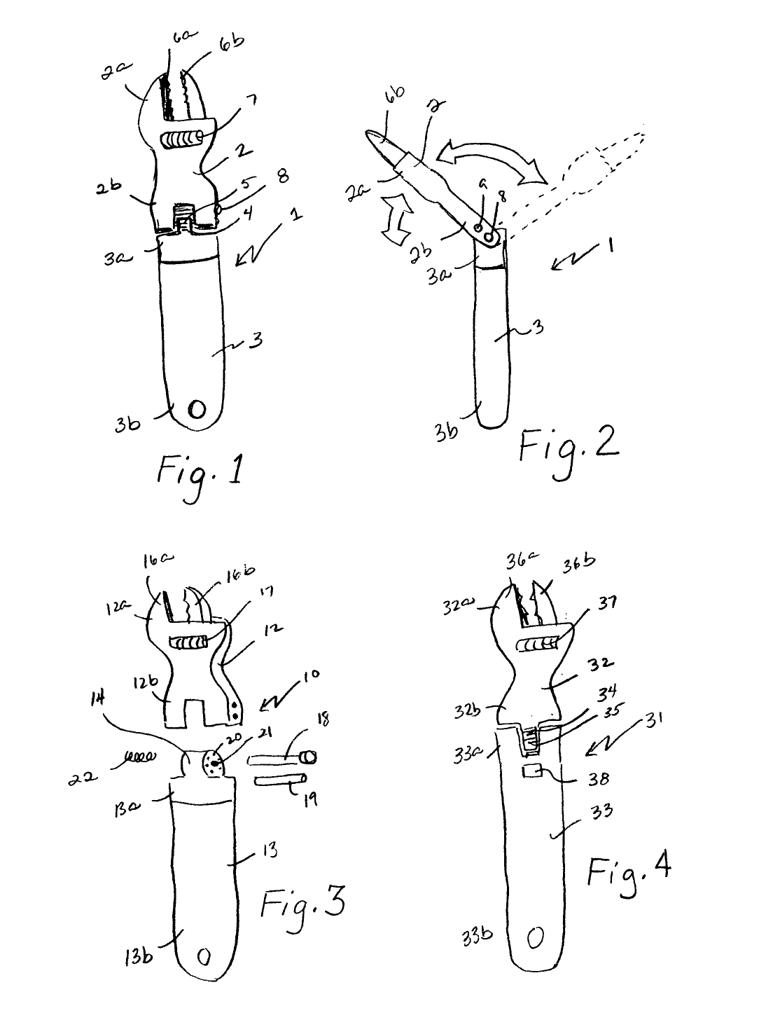

FIG. 1 illustrates one of the embodiments of the present invention, more specifically, a wrench device 1 having an adjustable head 2, and the device 1 comprises: a handle 3 having opposing top and bottom ends, 3a and 3b respectively. The top end 3a has a protrusion 4, and the protrusion 4 has a plurality of external slots 5. The wrench head 2 has opposing top and bottom ends, 2a and 2b and the top end 2a has at least one stationary wrench contact surface 6a and at least one moveable wrench contact surface 6b. The bottom end 2b of the wrench head 2 comprises a U-shaped component designed to interact with the protrusion of the top end of the handle 3. There is a device 7 for controlling the movement of the moveable wrench contact surface 6b to determine a distance between the stationary wrench contact surface 6a and the moveable wrench contact surface 6b. There is also a device 8 for engaging the slots 5 of the protrusion 4 to thereby allow movement of the wrench head 2 and lock the head 2 to a desired position.

FIG. 2 shows how the wrench head 2 is designed to rotate about an axis from about 0 degrees to about 180 degrees.

FIG. 3 illustrates another embodiment of the wrench device of the present invention. In this embodiment, the wrench 10 having an adjustable head 12, and the device 10 comprises: a handle 13 having opposing top and bottom ends, 13a and 13b respectively. The top end 13a has a protrusion 14, which has a plurality of apertures 20. The wrench head 12 having opposing top and bottom ends, 12a and 12b respectively. The top end 12a having at least one stationary wrench contact surface 16a and at least one moveable wrench contact surface 16b. The bottom end 12b of said wrench head 12 comprising a U-shaped component designed to interact with the protrusion 14 of the top end 13a of the handle 3. There is a device 17 for controlling the movement of the moveable wrench contact surface 16b to determine a distance between the stationary wrench contact surface 16a and the moveable wrench contact surface 16b. There is also a device 18 for engaging the apertures 20 of the protrusion to thereby allow movement of the wrench head 12 and lock the head to a desired position. The protrusion 4 comprises a central aperture 21 and the device further comprises a pin 19 for securing the wrench head 12 to the handle 13 by insertion of the pin 19 into the aperture 21 of the protrusion 14. In one embodiment, there is a release and locking device comprises a pin 18 and a spring 22.

FIG. 4 shows another embodiment of the present invention. The wrench device 31 has an adjustable head 32, and the device 31 comprises: a handle 33 has opposing top and bottom ends, 33a and 33b respectively, and the top end 33a has a U-shaped component. The wrench head 32 has opposing top and bottom ends, 32a and 32b respectively and the top end 32a has at least one stationary wrench contact surface 36a and at least one moveable wrench contact surface 36b. The bottom end 32b of the wrench head 32 comprising a protrusion 34 designed to interact with the U-shaped component of the top end 33a of the handle 33, and the protrusion 34 having a plurality of grooves 35. There is a device 37 for controlling the movement of the moveable wrench contact surface 36b to determine a distance between the stationary wrench contact surface 36a and the moveable wrench contact surface 36b; and a device 38 for engaging the grooves 35 of the protrusion 34 to thereby allow movement of the wrench head 32 and lock the head to a desired position, and the device 38 comprises a sliding mechanism which engages the grooves 35.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A wrench device having an adjustable head, said device comprising:
a handle having opposing top and bottom ends, said top end having a protrusion, said protrusion having a plurality of external slots;
a wrench head having opposing top and bottom ends, said top end having at least one stationary wrench contact surface and at least one moveable wrench contact surface, said bottom end of said wrench head comprising a U-shaped component designed to interact with said protrusion of said top end of said handle;
a device for controlling the movement of said moveable wrench contact surface to determine a distance between said stationary wrench contact surface and said moveable wrench contact surface; and
a device for engaging said slots of said protrusion to thereby allow movement of said wrench head and lock said head to a desired position.

2. The wrench device of claim 1 further comprising a device for activating the release and the locking of said head in a desired position.

3. The wrench device of claim 1 wherein said protrusion comprises an aperture and said device further comprises a pin for securing said wrench head to said handle by insertion of said pin into said aperture of said protrusion.

4. The wrench device of claim 2 wherein said release and locking device comprises a pin and a spring.

5. The wrench device of claim 1 wherein said wrench head is designed to rotate about an axis from about 0 degrees to about 180 degrees.

6. The wrench device of claim 1 wherein said bottom end of said handle comprises a grip.

7. The wrench device of claim 2 said release and locking device comprises push mechanism.

8. The wrench device of claim 2 said release and locking device comprises sliding mechanism.

9. The wrench device of claim 1 wherein said external slots of said protrusion functions as a gear.

10. A wrench device having an adjustable head, said device comprising:
a handle having opposing top and bottom ends, said top end having a protrusion, said protrusion having a plurality of apertures;
a wrench head having opposing top and bottom ends, said top end having at least one stationary wrench contact surface and at least one moveable wrench contact surface, said bottom end of said wrench head comprising a U-shaped component designed to interact with said protrusion of said top end of said handle;
a device for controlling the movement of said moveable wrench contact surface to determine a distance between said stationary wrench contact surface and said moveable wrench contact surface; and
a device for engaging said apertures of said protrusion to thereby allow movement of said wrench head and lock said head to a desired position.

11. The wrench device of claim 10 wherein said protrusion comprises a central aperture and said device further comprises a pin for securing said wrench head to said handle by insertion of said pin into said aperture of said protrusion.

12. The wrench device of claim 10 further comprising a device for activating the release and the locking of said head in a desired position.

13. The wrench device of claim 12 wherein said release and locking device comprises a pin and a spring.

14. The wrench device of claim 10 wherein said wrench head is designed to rotate about an axis from about 0 degrees to about 180 degrees.

15. The wrench device of claim 10 wherein said bottom end of said handle comprises a grip.

16. The wrench device of claim 12 said release and locking device comprises push mechanism.

17. A wrench device having an adjustable head, said device comprising:
a handle having opposing top and bottom ends, said top end having a U-shaped component;
a wrench head having opposing top and bottom ends, said top end having at least one stationary wrench contact surface and at least one moveable wrench contact surface, said bottom end of said wrench head comprising a protrusion designed to interact with said U-shaped component of said top end of said handle, said protrusion having a plurality of grooves;
a device for controlling the movement of said moveable wrench contact surface to determine a distance between said stationary wrench contact surface and said moveable wrench contact surface; and
a device for engaging said grooves of said protrusion to thereby allow movement of said wrench head and lock said head to a desired position, said device comprises a sliding mechanism which engages said grooves.

18. The wrench device of claim 17 wherein said protrusion comprises a central aperture and said device further comprises a pin for securing said wrench head to said handle by insertion of said pin into said aperture of said protrusion.

19. The wrench device of claim 17 wherein said wrench head is designed to rotate about an axis from about 0 degrees to about 180 degrees.

20. The wrench device of claim 17 wherein said bottom end of said handle comprises a grip.
